(19) United States
(12) Patent Application Publication
(10) Pub. No.: US 2024/0334104 A1
(43) Pub. Date: Oct. 3, 2024

(54) MICROPHONE-HIDDEN SPEAKER STRUCTURE

(71) Applicant: KUO SU, Xuancheng (CN)

(72) Inventor: KUO SU, Xuancheng (CN)

(21) Appl. No.: 18/738,174

(22) Filed: Jun. 10, 2024

(51) Int. Cl. H04R 1/02; H04R 1/08

(52) U.S. Cl. CPC H04R 1/025; H04R 1/08

(57) ABSTRACT

Disclosed is a microphone-hidden speaker structure, including a housing, a microphone accommodating cavity that extends inwards and has a certain depth is formed on the housing, and a recess is formed on one end of the microphone accommodating cavity; the speaker main body further includes a decorative cover plate, and the decorative cover plate is made of soft material with a certain elasticity or hard material; and the decorative cover plate is embedded above the microphone accommodating cavity, and the decorative cover plate is detachably connected to the housing.

### TECHNICAL FIELD

The present disclosure relates to the field of speakers, and particularly to a microphone-hidden speaker structure.

### BACKGROUND

A speaker is a device for playing audios and is very popular among consumers. Especially, a currently popular Karaoke speaker, provided with a microphone, can be used for singing and entertainment, and is very convenient.

However, for the speakers with microphones currently available on the market, the microphone accommodating cavities are all formed on upper surfaces of housings, but the microphone accommodating cavities are not provided with any decorative cover plates, making the overall flatness of the speakers poor, thereby affecting the aesthetics; furthermore, the microphones are usually accommodated in the accommodating cavities, without being hidden, making the microphones are easily accessed by children, as a result, children can take out, play with, or even damage the microphones.

### SUMMARY

In order to overcome the defects in the prior art, the present disclosure provides a microphone-hidden speaker structure to solve the problems mentioned in the background art.

In order to implement the above objective, the present disclosure provides a microphone-hidden speaker structure, including a speaker main body, where the speaker main body includes a housing, a microphone accommodating cavity that extends inwards and has a certain depth is formed on the housing, and a recess is formed on one end of the microphone accommodating cavity; and

the speaker main body further includes a decorative cover plate, and the decorative cover plate is made of soft material with a certain elasticity or hard material; and the decorative cover plate is embedded above the microphone accommodating cavity, and the decorative cover plate is detachably connected to the housing.

Further, one side of the decorative cover plate is provided with an annular snap-fitting stand protruding from the surface of the decorative cover plate.

Further, a plurality of sets of rubber pads are annularly arranged on a side edge of the annular snap-fitting stand, and the rubber pads protrude from the side edge of the annular snap-fitting stand.

Further, the annular snap-fitting stand is adapted to an opening of the microphone accommodating cavity, the annular snap-fitting stand on the decorative cover plate is snapped into the opening of the microphone accommodating cavity, the rubber pads on the side edge of the annular snap-fitting stand are squeezed and deformed to contact with the inner side wall of the microphone accommodating cavity, such that quick mounting and fixation of the decorative cover plate are realized.

Further, a notch is formed on the decorative cover plate.

Further, the speaker main body further includes a microphone, where the microphone is adapted to the microphone accommodating cavity, and the microphone is fixed inside the microphone accommodating cavity by means of snap-fitting or magnetic attraction; and

a flexible buffer pad is arranged inside the microphone accommodating cavity.

Further, snap-in holes are formed on the housing, and the snap-in holes are arranged on a side edge close to the microphone accommodating cavity.

Further, snap-fitting columns are arranged on the decorative cover plate, the snap-fitting columns and the snap-in holes are opposite each other, and quick installation and fixation of the decorative cover plate are completed when the snap-fitting columns on the decorative cover plate are snapped into the snap-in holes.

Further, the housing is provided with a first magnetic attraction piece, and the first magnetic attraction piece is arranged on a side edge close to the microphone accommodating cavity.

Further, the decorative cover plate is provided with a second magnetic attraction piece, the first magnetic attraction piece and the second magnetic attraction piece are opposite each other, and the decorative cover plate is fixed on the housing through the first magnetic attraction piece and the second magnetic attraction piece.

Compared with the prior art, the present disclosure has the following beneficial effects:
1. In the present disclosure, a microphone accommodating cavity that extends inwards and has a certain depth for accommodating the microphone is formed on the housing, after the microphone is placed inside the microphone accommodating cavity, the cavity is covered with the decorative cover plate, such that the microphone-hidden speaker structure is implemented, and the structure becomes more beautiful.
2. The decorative cover plate is made of soft material, such that noises generated by vibrations of the decorative cover plate when the speaker plays audios can be reduced. When the decorative cover plate is made of hard material, the rubber pads are employed, such that a certain gap is formed between the decorative cover plate and the housing, and resonance between the decorative cover plate and the housing is effectively reduced.
3. The decorative cover plate is fixed on the housing by means of snap-in, snap fastening or magnetic attraction, and the decorative cover plate can be installed or removed quickly, making it convenient for users to store the microphone or take the microphone out from the microphone accommodating cavity.

### BRIEF DESCRIPTION OF THE DRAWINGS

FIG. 1 is a schematic diagram of a decorative cover in a separated state according to Embodiment 1 of the present disclosure.

FIG. 2 is an overall structural schematic diagram of Embodiment 1 of the present disclosure.

FIG. 3 is a schematic diagram is a decorative structure according to Embodiment 1 of the present disclosure.

FIG. 4 is a structural schematic diagram of a housing according to Embodiment 2 in the present disclosure.

FIG. 5 is a structural schematic diagram of a decorative cover plate according to Embodiment 2 in the present disclosure.

FIG. 6 is a structural schematic diagram of a housing according to Embodiment 3 in the present disclosure.

FIG. 7 is a structural schematic diagram of a decorative cover plate according to Embodiment 3 in the present disclosure.

In the drawings: 1. speaker main body; 11. housing; 12. decorative cover plate; 14. microphone; 111. microphone accommodating cavity; 112. recess; 113. flexible buffer pad; 121. annular snap-fitting stand; 122. notch; 20. snap-in hole; 30. snap-fitting column; 40. first magnetic attraction piece; 50. second magnetic attraction piece; and 1211. rubber pad.

### DETAILED DESCRIPTIONS OF THE EMBODIMENTS

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinary skill in the art, the specific meanings of the terms described above in the present disclosure may be interpreted according to specific circumstances.

The present disclosure will be further described below in conjunction with the accompanying drawings and specific embodiments:

### Embodiment 1

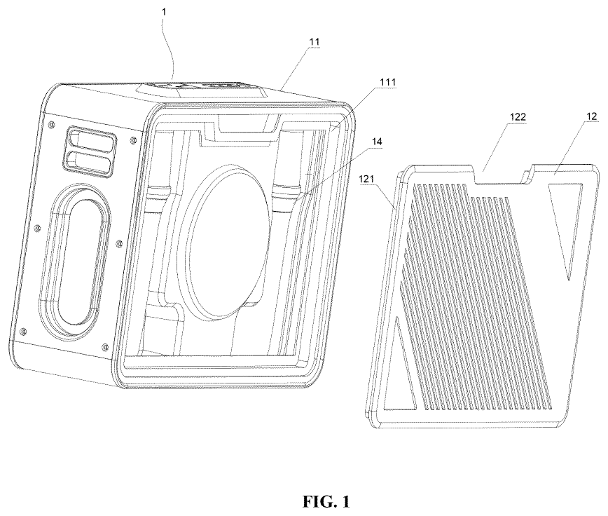

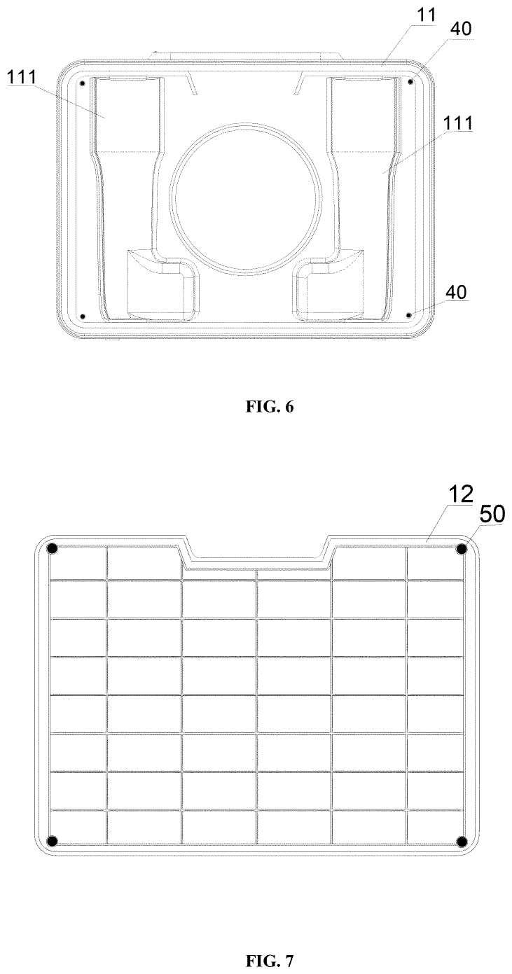

This embodiment provides a microphone-hidden speaker structure, as shown in FIGS. 1-6, including a speaker main body 1, where the speaker main body 1 includes a housing 11, and a microphone accommodating cavity 111 that extends inwards and has a certain depth is formed on the housing 11; in the present disclosure, the microphone accommodating cavity 111 is arranged in two groups, where the microphone accommodating cavity 111 is vertically formed on the back surface of the housing 11, a recess 112 is formed on one end of the microphone accommodating cavity 111, the recess 112 is arranged at the bottom of the microphone accommodating cavity 111, and the arrangement of the recess 112 is convenient for a user to take a microphone 14 fixed inside the microphone accommodating cavity 111; and the speaker main body 1 further includes a decorative cover plate 12, and the decorative cover plate 12 is made of soft material with a certain elasticity or hard material; and the decorative cover plate 12 is embedded above the microphone accommodating cavity 111, and the decorative cover plate 12 is detachably connected to the housing 11.

In some embodiments, as shown in FIGS. 1-5, one side of the decorative cover plate 12 is provided with an annular snap-fitting stand 121 protruding from the surface of the decorative cover plate 12, when the decorative cover plate 12 is made of hard material, a plurality of sets of rubber pads 1211 are annularly arranged on a side edge of the annular snap-fitting stand 121, the rubber pads 1211 protrude from the side edge of the annular snap-fitting stand 121, the annular snap-fitting stand 121 is adapted to an opening of the microphone accommodating cavity 111, and the annular snap-fitting stand 121 on the decorative cover plate 12 is snapped into the opening of the microphone accommodating cavity 111; the rubber pads 1211 on the side edge of the annular snap-fitting stand 121 are squeezed and deformed to contact with the inner side wall of the microphone accommodating cavity 111, such that a certain gap is formed between the decorative cover plate 12 made of the hard material and the housing 11, which is conducive to beneficial to reducing resonance; and the rubber pads 1211 can be employed to fix the decorative cover plate 12, such that the decorative cover plate 12 can be quickly mounted and fixed, as well as quickly removed, making the usage very convenient and facilitating the taking of the microphone 14 by the user.

In such a way, in other embodiments, the decorative cover plate 12 can be made of soft silicone material with a certain elasticity to prevent resonance and noise between the decorative cover plate 12 and the housing 11 when the speaker plays audios.

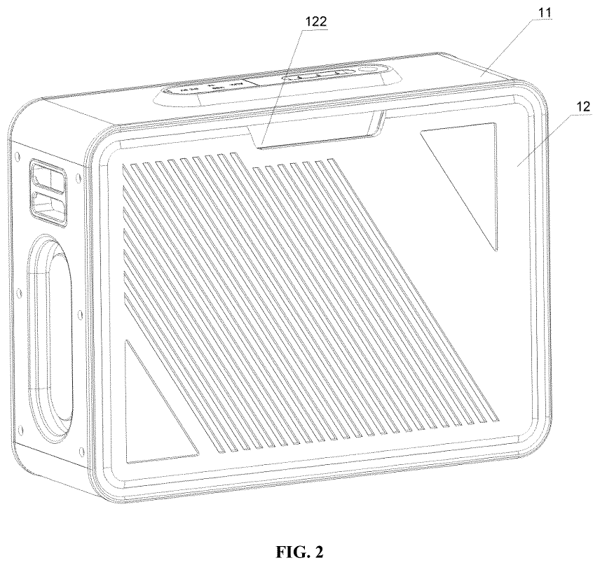

As shown in FIGS. 1-2, a notch 122 is formed on the decorative cover plate 12, the notch 122 is arranged on one side of the decorative cover plate 12, and the arrangement of the notch 122 is convenient for the user to quickly remove the decorative cover plate 12.

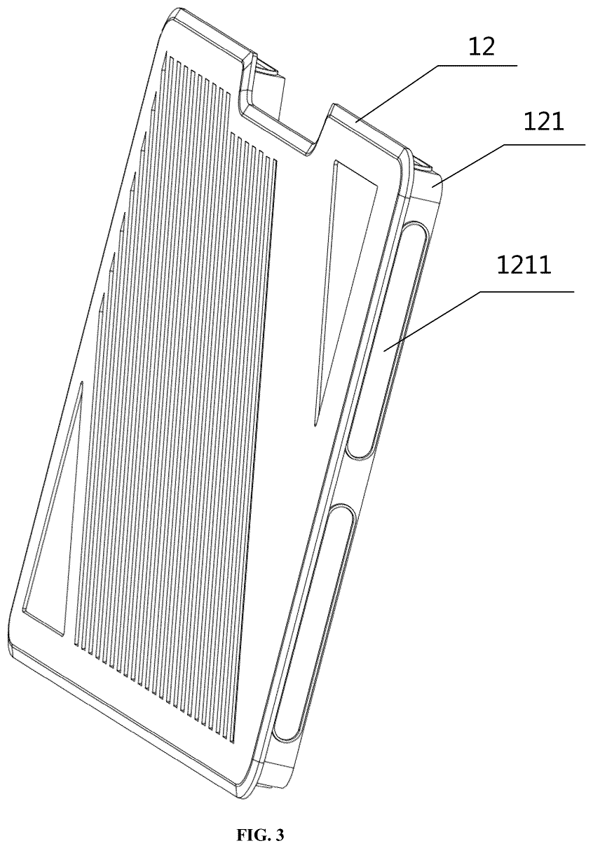

As shown in FIG. 3, the speaker main body 1 further includes the microphone 14, where the microphone 14 is adapted to the microphone accommodating cavity 111, and the microphone 14 is fixed inside the microphone accommodating cavity 111 by means of snap fastening or magnetic attraction; a flexible buffer pad 113 is arranged inside the microphone accommodating cavity 111, and the microphone 14 is arranged in two groups; and the arrangement of the flexible buffer pad 113 effectively reduces the hard contact between the microphone 14 and the housing 11, which is beneficial to reducing noise caused by resonance, and to preventing a casing of microphone 14 from being scratched by the hard housing 11 due to friction when the microphone 14 is taken.

### Embodiment 2

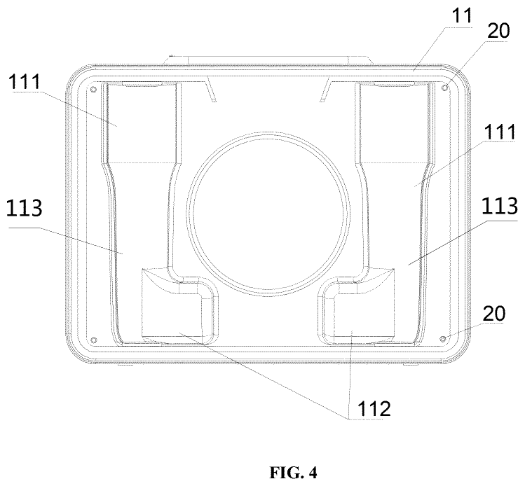

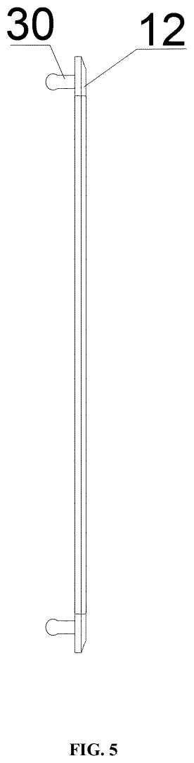

As shown in FIGS. 4-5, snap-in holes 20 are formed on the housing 11, the snap-in holes 20 are arranged on a side edge close to the microphone accommodating cavity 111, the snap-in holes 20 are arranged in four groups at four corners of the housing 11, respectively, snap-fitting columns 30 are arranged on the decorative cover plate 12, the snap-fitting columns 30 are adapted to the snap-in holes 20, and the snap-fitting columns 30 and the snap-in holes 20 are opposite each other; the snap-fitting columns 30 made of material with a certain flexibility and elasticity, or rubber pads are arranged on the inner side walls of the snap-in holes 20 prevent the decorative cover plate 12 from hard contact with the housing 11 and generating resonance or noise; and when the snap-fitting columns 30 on the decorative cover plate 12 are snapped into the snap-in holes 20, quick installation and fixation of the decorative cover plate 12 are completed, and quick removal of the decorative cover plate 12 can also be completed in such a way, making the usage very convenient and facilitating the taking of the microphone 14 by the user.

### Embodiment 3

As shown in FIGS. 5-7, the housing 11 is provided with a first magnetic attraction piece 40, the first magnetic attraction piece 40 is arranged on a side edge close to the microphone accommodating cavity 111, the decorative cover plate 12 is provided with a second magnetic attraction piece 50, the first magnetic attraction piece 40 and the second magnetic attraction piece 50 are opposite each other, and the decorative cover plate 12 is fixed on the housing 11 through the first magnetic attraction piece 40 and the second magnetic attraction piece 50; the first magnetic attraction piece 40 is set as a magnet or an iron sheet, the second magnetic attraction piece 50 is correspondingly set as an iron sheet or a magnet, and the first magnetic attraction piece 40 and the second magnetic attraction piece 50 can also be set as magnets which are magnetically attracted to each other; and the first magnetic attraction piece 40 is embedded at the four corners of the housing 11, and is opposite to the second magnetic attraction piece 50, when the decorative cover plate 12 is clasped on the housing 11, the first magnetic attraction piece 40 and the second magnetic attraction piece 50 are attracted to each other for fixation, making the usage very convenient, as well as the installation and removal of the decorative cover plate 12 quick and convenient, and facilitating the taking of the microphone 14 by the user. It should be noted that when the first magnetic attraction piece 40 and the second magnetic attraction piece 50 are attracted together, a certain gap is formed between them to avoid hard connection between the magnets or between the magnet or the iron sheet, and to avoid resonance and noise produced between the decorative cover plate 12 and the housing 11.

The above descriptions are only preferred embodiments of the present disclosure, and are not intended to be limiting of the present disclosure, and various changes and modifications may be made by those skilled in the art. Any modification, equivalent replacement, improvement, etc. made within the spirit and principle of the present disclosure shall fall within the protection scope of the present disclosure.

What it claimed is:

1. A microphone-hidden speaker structure, comprising a speaker main body (1), wherein the speaker main body (1) comprises a housing (11), a microphone accommodating cavity (111) that extends inwards and has a certain depth is formed on the housing (11), and a recess (112) is formed on one end of the microphone accommodating cavity (111);
the speaker main body (1) further comprises a decorative cover plate (12), and the decorative cover plate (12) is made of soft material with a certain elasticity or hard material; and
the decorative cover plate (12) is embedded above the microphone accommodating cavity (111), and the decorative cover plate (12) is detachably connected to the housing (11).

2. The microphone-hidden speaker structure according to claim 1, wherein one side of the decorative cover plate (12) is provided with an annular snap-fitting stand (121) protruding from the surface of the decorative cover plate (12).

3. The microphone-hidden speaker structure according to claim 2, wherein a plurality of sets of rubber pads (1211) are annularly arranged on a side edge of the annular snap-fitting stand (121), and the rubber pads (1211) protrude from the side edge of the annular snap-fitting stand (121).

4. The microphone-hidden speaker structure according to claim 2, wherein the annular snap-fitting stand (121) is adapted to an opening of the microphone accommodating cavity (111), the annular snap-fitting stand (121) on the decorative cover plate (12) is snapped into the opening of the microphone accommodating cavity (111), the rubber pads (1211) on the side edge of the annular snap-fitting stand (121) are squeezed and deformed to contact with the inner side wall of the microphone accommodating cavity (111), such that quick mounting and fixation of the decorative cover plate (12) are realized.

5. The microphone-hidden speaker structure according to claim 4, wherein a notch (122) is formed on the decorative cover plate (12).

6. The microphone-hidden speaker structure according to claim 1, wherein the speaker main body (1) further comprises a microphone (14), wherein the microphone (14) is adapted to the microphone accommodating cavity (111), and the microphone (14) is fixed inside the microphone accommodating cavity (111) by means of snap-fitting or magnetic attraction; and
a flexible buffer pad (113) is arranged inside the microphone accommodating cavity (111).

7. The microphone-hidden speaker structure according to claim 1, wherein snap-in holes (20) are formed on the housing (11), and the snap-in holes (20) are arranged on a side edge close to the microphone accommodating cavity (111).

8. The microphone-hidden speaker structure according to claim 1, wherein snap-fitting columns (30) are arranged on the decorative cover plate (12), the snap-fitting columns (30) and the snap-in holes (20) are opposite each other, and quick installation and fixation of the decorative cover plate (12) are completed when the snap-fitting columns (30) on the decorative cover plate (12) are snapped into the snap-in holes (20).

9. The microphone-hidden speaker structure according to claim 1, wherein the housing (11) is provided with a first magnetic attraction piece (40), and the first magnetic attraction piece (40) is arranged on a side edge close to the microphone accommodating cavity (111).

10. The microphone-hidden speaker structure according to claim 9, wherein the decorative cover plate (12) is provided with a second magnetic attraction piece (50), the first magnetic attraction piece (40) and the second magnetic attraction piece (50) are opposite each other, and the decorative cover plate (12) is fixed on the housing (11) through the first magnetic attraction piece (40) and the second magnetic attraction piece (50).
